(19) United States
(12) Patent Application Publication
(10) Pub. No.: US 2025/0062615 A1
(43) Pub. Date: Feb. 20, 2025

(54) POWER GENERATION PREDICTION METHOD FOR DISTRIBUTED POWER PLANT USING REINFORCEMENT LEARNING

(71) Applicant: REC's Innovation Co., Ltd., Naju-si (KR)

(72) Inventor: Jeong Min IM, Naju-si (KR)

(73) Assignee: REC's Innovation Co., Ltd., Naju-si (KR)

(21) Appl. No.: 18/804,855

(22) Filed: Aug. 14, 2024

(30) Foreign Application Priority Data
Aug. 16, 2023 (KR) 10-2023-0107068

(51) Int. Cl. H02J 3/00; H02J 3/38

(52) U.S. Cl. CPC H02J 3/004; H02J 3/381; H02J 2203/20; H02J 2300/22

(57) ABSTRACT

A power generation prediction method for distributed power plants using reinforcement learning according to an embodiment of the present disclosure is a method of predicting power generation of each of a plurality of distributedly installed power plants using a neural network model. The method includes: creating a plurality of reference clusters by clustering environmental variables accumulatively collected from each of the power plants; creating a new cluster by collecting new environmental variables from a new power plant and by clustering the new environmental variables; and additionally using the new environmental variables for reinforcement learning of the neural network model on the basis of similarity between the plurality of reference clusters and the new cluster.

### CROSS REFERENCE TO RELATED APPLICATION

The present application claims priority to Korean Patent Applications No. 10-2023-0107068, filed Aug. 16, 2023, the entire contents of which are incorporated herein for all purposes by this reference.

### BACKGROUND

### Technical Field

The present disclosure relates to a method of predicting power generation of multiple distributed power plants through a neural network model that is continuously reinforcement-trained.

### Description of the Related Art

Distributed power plants refer to small-scale renewable energy generation facilities distributedly installed in different areas such as wind power generation, solar power generation, and hydro power generation, and generally, are installed near areas of electricity demand and serve to supply power.

In order to economically integrate and manage these distributed power plants, it is essential to accurately predict the power generation of each plant, and recently, there has been a trend of using artificial intelligence models to improve the accuracy in prediction of power generation.

However, AI models, once trained, guarantees high performance on data with certain trends. However, since distributed power plants are installed individually in different environments, AI models trained on existing data have limitations that they are difficult to be used for predicting the power generation of newly installed distributed power plants.

### SUMMARY

An objective of the present disclosure is to determine whether to perform additional reinforcement learning of a neural network model on the basis of environmental variables that are collected from a new power plant when predicting the power generation of multiple distributed power plants.

The objectives of the present disclosure are not limited to those described above and other objectives and advantages not stated herein may be understood through the following description and may be clear by embodiments of the present disclosure. Further, it would be easily known that the objectives and advantages of the present disclosure may be achieved by the configurations described in claims and combinations thereof.

In order to achieve the objectives described above, a power generation prediction method for distributed power plants using reinforcement learning according to an embodiment of the present disclosure is a method of predicting power generation of each of a plurality of distributedly installed power plants using a neural network model. The method includes: creating a plurality of reference clusters by clustering environmental variables accumulatively collected from each of the power plants; creating a new cluster by collecting new environmental variables from a new power plant and by clustering the new environmental variables; and additionally using the new environmental variables for reinforcement learning of the neural network model on the basis of similarity between the plurality of reference clusters and the new cluster.

When power generation of multiple distributed power plants is predicted through the neural network model, whether to additionally reinforcement-train the neural network model is determined on the basis of environmental variables collected from a new power plant, whereby the present disclosure has the advantage that it is not required to train the neural network model using a lot of time and resources every time a plant, which is a subject of management, is introduced when integrally managing the multiple power plants.

Detailed effects of the present disclosure in addition to the above effects will be described with the following detailed description for accomplishing the present disclosure.

### BRIEF DESCRIPTION OF THE DRAWINGS

The above and other objectives, features and other advantages of the present disclosure will be more clearly understood from the following detailed description when taken in conjunction with the accompanying drawings, in which:

FIG. 1 is a diagram showing a power generation prediction system for distributed power plants according to an embodiment of the present disclosure;

FIG. 2 is a flowchart showing a power generation prediction method for distributed power plants using reinforcement learning according to an embodiment of the present disclosure;

FIG. 3 is a diagram illustrating a reinforcement learning process of a neural network model of the present disclosure;

FIG. 4 is a diagram showing the state in which environmental variables accumulatively collected from an existing power plant have been clustered; and

FIGS. 5 and 6 are diagrams each showing the state in which new environmental variables collected from a new power plant have been clustered.

### DETAILED DESCRIPTION

The objects, characteristics, and advantages will be described in detail below with reference to the accompanying drawings, so those skilled in the art may easily achieve the spirit of the present disclosure. However, in describing the present disclosure, detailed descriptions of well-known technologies will be omitted so as not to obscure the description of the present disclosure with unnecessary details. Hereinafter, exemplary embodiments of the present disclosure will be described with reference to accompanying drawings. The same reference numerals are used to indicate the same or similar components in the drawings.

Although terms “first”, “second”, etc. are used to describe various components in the specification, it should be noted that these components are not limited by the terms. These terms are used to discriminate one component from another component and it is apparent that a first component may be a second component unless specifically stated otherwise.

Further, when a certain configuration is disposed “over (or under)” or “on (beneath)” a component in the specification, it may mean not only that the certain configuration is disposed on the top (or bottom) of the component, but that another configuration may be interposed between the component and the certain configuration disposed on (or beneath) the component.

Further, when a certain component is “connected”, “coupled”, or “jointed” to another component in the specification, it should be understood that the components may be directly connected or jointed to each other, but another component may be “interposed” between the components or the components may be “connected”, “coupled”, or “jointed” through another component.

Further, singular forms that are used in this specification are intended to include plural forms unless the context clearly indicates otherwise. In the specification, terms “configured”, “include”, or the like should not be construed as necessarily including several components or several steps described herein, in which some of the components or steps may not be included or additional components or steps may be further included.

Further, the term “A and/or B” stated in the specification means that A, B, or A and B unless specifically stated otherwise, and the term “C to D” means that C or more and D or less unless specifically stated otherwise.

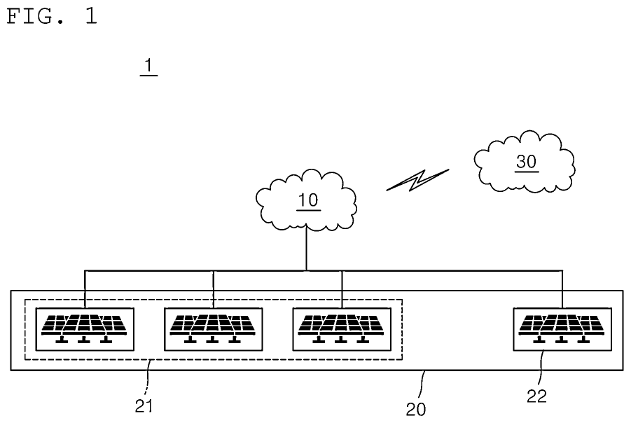

The present disclosure relates to a method of determining whether to perform reinforcement learning of a neural network model on the basis of environmental variables that are collected from a new power plant when predicting the power generation amount of multiple distributed power plants. Hereafter, a power generation prediction method for distributed power plants using reinforcement learning (hereafter, power generation prediction method) is described in detail with reference to FIGS. 1 to 6.

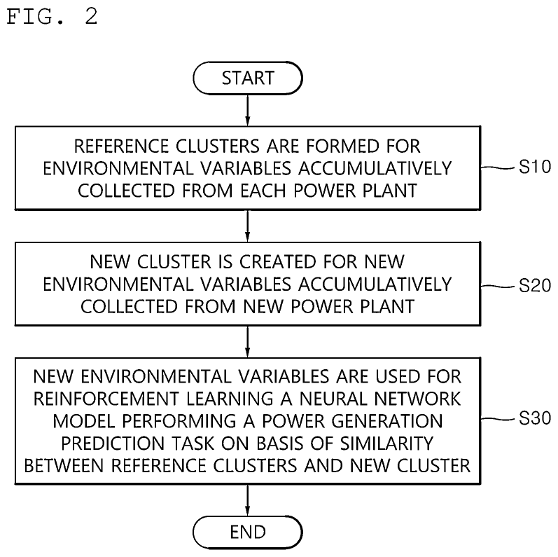

FIG. 1 is a diagram showing a power generation prediction system for distributed power plants according to an embodiment of the present disclosure and FIG. 2 is a flowchart showing a power generation prediction method for distributed power plants using reinforcement learning according to an embodiment of the present disclosure.

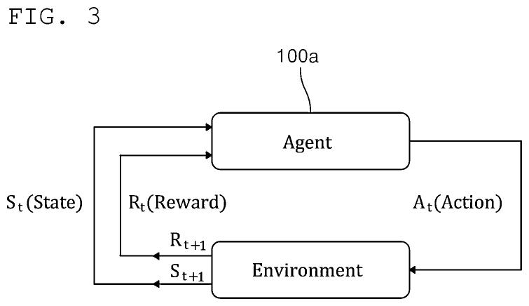

FIG. 3 is a diagram illustrating a reinforcement learning process of a neural network model of the present disclosure.

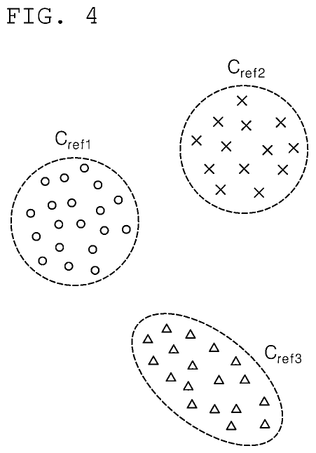

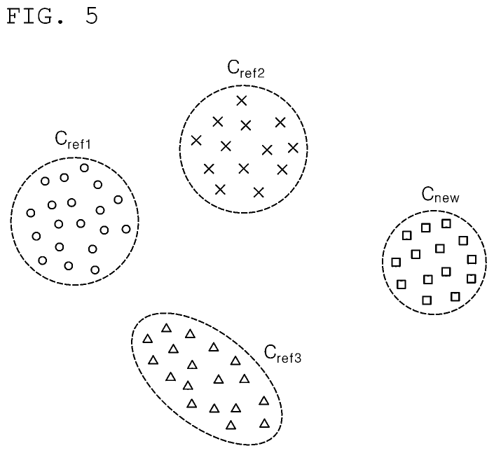

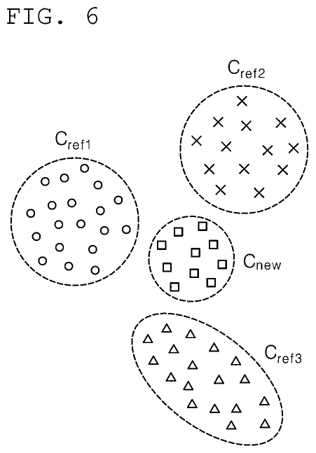

FIG. 4 is a diagram showing the state in which environmental variables accumulatively collected from an existing power plant have been clustered and FIGS. 5 and 6 are diagrams each showing the state in which new environmental variables collected from a new power plant have been clustered.

Referring to FIG. 1, a power generation prediction system 1 for distributed power plants according to an embodiment may include a server 10, an external server 30, and multiple power plants 20 that are distributedly installed. However, the power generation prediction system 1 shown in FIG. 1 is based on an embodiment, the components of the system 1 are not limited to the embodiment shown in FIG. 1, and if necessary, some components may be added, changed, or removed.

The power plants 20 may include certain facilities that can generate power such as a power plant that uses fossil fuel or power plants that use renewable energy such as a solar power plant, a wind power plant, a tidal power plant. However, the power plants 20 may be the same type of power plants, for example, solar power plants such that comparison of environmental variables to be described below should be significant. Meanwhile, the multiple power plants 20 shown in FIG. 1, for the convenience of description, may be described as a plurality of existing power plants 21 and any one new power plant 22.

The server 10, which is a subject that performs the power generation prediction method of the present disclosure, as shown in FIG. 1, may be connected with a plurality of distributedly installed power plants and may be constructed in a management system that manages the power plants.

The server may include a computing device such as a Central Processing Unit (CPU) and a Graphic Processing Unit (GPU) to perform computation. Further, the server 10 may include at least one physical element of application specific integrated circuits (ASICs), digital signal processors (DSPs), (digital signal processing devices (DSPDs), programmable logic devices (PLDs), field programmable gate arrays (FPGAs), a processor, a microprocessor, a controller, and a micro-controller.

Meanwhile, the external server 30 stated in the specification is a subject providing information that is the base of the operation of the server 10, and may be a concept including different servers corresponding to provided information. That is, the external server 30 may be a concept generally referring to a plurality of servers, depending on provided information, rather than one server.

Referring to FIG. 2, a power generation prediction method according to an embodiment of the present disclosure may include: creating a reference cluster for environmental variables accumulatively collected from power plants (S10); creating a new cluster for a new environmental variable collected from a new power plant (S200; and additionally using the new environmental variable for reinforcement learning of a neural network model that performs a power generation prediction task on the basis of similarity between the reference cluster and the new cluster (S30).

However, the power generation prediction method shown in FIG. 2 is based on an embodiment, the steps of the present disclosure are not limited to the embodiment shown in FIG. 2, and if necessary, some steps may be added, changed, or removed.

A method in which the server 10 predicts power generation of each of distributedly installed power plants 20 using a neural network model is described before the steps shown in FIG. 2 are described.

The neural network model 100 of the present disclosure can perform a task of predicting power generation on the basis of environmental variables, and for this purpose, it can be reinforcement-trained by the server 10. The neural network model 100 may be implemented as various models that are used for value-based or policy-based reinforcement learning.

Referring to FIG. 3 as an example, reinforcement leaning can be performed by defining an environment, an agent, a state, an action, and a reward. In this case, the environment may mean a space of a background in which learning is performed, and the agent may be a subject that takes actions in interaction with an environment. The state may mean a situation of an agent given in an environment and the action may mean determination by an agent in a given environment. The reward may mean a reward accompanying an action of an agent in a current environment and reinforcement learning may be an algorithm that enables an agent to act in a way that maximizes a reward.

In this structure, the neural network model 100 of the present disclosure can function as an agent, the server 100 can provide the neural network model 100 with a state value Sₜ and a reward value Rₜ, and the neural network model 100 can set an algorithm to maximize a reward value Rₜ accompanying its action Aₜ. Methods of implementing reinforcement learning have been well known in the art, so the methods are not described in more detail.

Referring to FIG. 3 again, in order for the neural network model 100 to perform the power generation prediction task, the server 10 can set environment variables for respective date accumulatively collected from the existing power plants 21 as state values Sₜ. The neural network model 100 can output predicted power generation for each date as an action value Aₜ in a preset range, and in this case, the server 10 can set a reward value Rₜ inversely proportional to the difference between predicted power generation output from the neural network model 100 and actual power generation for each date.

Such reinforcement learning can be performed for each past date, and, as learning is repeated, the neural network model 100 can select predicted power generation such that the reward value Rₜ becomes maximum, that is, the difference between predicted power generation and actual power generation becomes minimum.

The server 10 can predict power generation by applying the neural network model 100 trained as described above to all of the distributed power plants 20. For example, in order to predict power generation of a power plant A on a target data in the future, the server 10 first can collect predicted environmental variables for the target date at the installation location of the power plant A from the external server 30. For example, when the power plant A is a solar power plant, the server can collect environmental variables such as hours of sunlight, atmospheric temperature, cloud cover, moisture, and precipitation forecasted for the installation location of the power plant A from an external server 30 that is managed by a meteorological administration.

Then, the server 10 can input the collected environmental variables into the neural network model 100. Since the neural network model 100 has been trained to select predicted power generation corresponding to environmental variables by reinforcement learning described above, it can output predicted power generation on a target date by receiving predicted environmental variables for the target date that were not used for learning.

In this way, the server 10 can apply a single neural network model 100 to the power generation of all of distributed power plants.

Meanwhile, in the present disclosure, environmental variables may include certain environmental factors that may have an influence on power generation, and may include various environmental factors other than hours of sunlight, atmospheric temperature, cloud cover, moisture, and precipitation, depending on the generation types of power plants.

When the neural network model 100 is used in power generation prediction, many environmental variables and a source for processing the environmental variables are required for reinforcement learning, but there is a limitation that it is substantially difficult for the server 10 that controls multiple power plants 20 to perform re-training additionally using environmental variables collected from a new power plant 22 every time a new power plant 22 is introduced.

The present disclosure has been made with this awareness of the problem and is characterized by determining whether to additionally perform training, depending on environmental variables that are collected from a new power plant 22. Hereafter, the steps shown in FIG. 2 are described in detail.

The server 10 can create a plurality of reference clusters by clustering environmental variables accumulatively collected from each of the power plants 20 (S10). As described above, environmental variables include environmental factors that may influence power generation and such environmental variables can be obtained through a plurality of environmental sensors installed at the power plants 20, respectively.

The server 10 may collect environmental variables directly from environmental sensors or may collect environmental variables through systems such as an Energy Management System (EMS) that manages the resources of each of the power plants 20. Such a collection operation may be continuously performed over time and the server can accumulatively store collected environmental variables into a database. The accumulatively stored environmental variables can be used to train the neural network model 100 described above.

Next, the server 10 can create a plurality of reference clusters by clustering accumulatively collected and stored environmental variables in accordance with similarity.

Referring to FIG. 4, the server 10 can calculate similarity between individual environmental variables and can cluster the environmental variables on the basis of similarity. Since the power plants 20 may be installed at different locations, environmental variables that are collected from each of the power plants 20 may have tendency based on the geometric characteristics.

For example, as shown in FIG. 4, the environmental variables collected from a first power plant 20 can form a first cluster C_{ref1} with high similarity, the environmental variables collected from a second power plant 20 also can form a second cluster C_{ref2} with high similarity, the environmental variables collected from a third power plant 20 also can form a third cluster C_{ref3} with high similarity.

Referring to FIG. 1 again, when the server 10 manages multiple existing power plants 21, a situation in which the server 10 has to additionally manage a new power plant 22 due to installation of a new power plant 20 or introduction of a power plant 20 that has not been managed before.

In this case, the server 10 can create a new cluster by collecting new environmental variables from the new power plant 22 and clustering the new environmental variables (S20). When a new power plant 22 that is not registered on a database is introduced as a subject of management, the server 10 can collect new environmental variables from a plurality of environmental sensors of the new power plant 22. The collection period of new environmental variables can be set by a user, and for example, can be set as 1 month.

In this case, the new environmental variables that are collected may be the same kind as the environmental variables accumulatively collected from the existing power plants 21. For example, when the environmental variables accumulatively collected from the existing power plants 21 are hours of sunlight, atmospheric temperature, cloud cover, moisture, and precipitation, the new environmental variables collected from the new power plant 22 may also be hours of sunlight, atmospheric temperature, cloud cover, moisture, and precipitation.

Referring to FIG. 5, the environmental variables collected from the new power plant 22 may have tendency in accordance with the geometric characteristics of the installation location of the new power plant 22 and can form a new cluster C_{new} different from the environmental variables collected from the existing power plants 21.

The sever 10 can determine whether to additionally train the neural network model 100 by comparing the reference cluster C_{ref} created before with the new cluster C_{new}. In detail, the sever 10 can use new environmental variables for reinforcement learning of the neural network model 100 on the basis of the similarity between the reference cluster C_{ref} created before and the new cluster C_{new} (S30).

As exemplified in FIG. 5, the new cluster C_{new} may be created at a location different from the reference cluster C_{ref}. The server 10 can calculate the similarity between each reference cluster C_{ref} and the new cluster C_{new}.

In an embodiment, the server 10 can calculate the distance between a representative value of each of a plurality of reference clusters C_{ref} and a representative value of the new cluster C_{new} and can determine similarity inversely proportional to the calculated distance.

In detail, the server 10 can set the mean or the median of the environmental variables included in each of the reference clusters C_{ref} as the representative value of each of the reference clusters C_{ref} and can set the mean or the median of the environmental variables included in the new cluster C_{new} as the representative value of the new cluster C_{new}. Next, the server 10 can calculate the distance between each of the representative values of the reference clusters C_{ref} and the representative value of the new cluster C_{new} and can determine similarity inversely proportional to the distances.

Further, in an embodiment, the server 10 can calculate the distance between the representative value closest to the center of each reference cluster C_{ref} in the environmental variables included in a plurality of reference clusters C_{ref} and the representative value closest to the center of the new cluster C_{new}, and can determine similarity inversely proportional to the calculated distances.

In detail, as shown in FIG. 5, each cluster may be drawn in a circle or an ellipse. The server 10 can recognize the centers of clusters and can set an environmental variable closest to the center in the environmental variables pertaining to each of the clusters as a representative value. Meanwhile, when a cluster is not a circle or an ellipse, the server 10 can recognize the center of gravity of the region formed by the cluster as the center of the cluster. Next, the server 10 can calculate the distance between each of the representative values of the reference clusters C_{ref} and the representative value of the new cluster C_{new} and can determine similarity inversely proportional to the distances.

Further, in an embodiment, the server 10 can calculate the distance between the representative value closest to the mean of each reference cluster C_{ref} in the environmental variables included in a plurality of reference clusters C_{ref} and the representative value closest to the mean of the new cluster C_{new}.

In detail, the server 1 can calculate the means of the environmental variables included in each cluster and can set any one environmental variable closest to the mean in the environmental variables pertaining to each cluster as a representative value. Next, the server 10 can calculate the distance between each of the representative values of the reference clusters C_{ref} and the representative value of the new cluster C_{new} and can determine similarity inversely proportional to the distances.

Further, in an embodiment, the server 10 can calculate a silhouette value of a new cluster C_{new} for a plurality of reference clusters C_{ref} or can calculate a silhouette coefficient for the plurality of reference clusters C_{ref} and the new cluster C_{new} and can determine similarity proportional to the calculated silhouette value or coefficient.

In detail, when a reference cluster C_{ref} is defined as C_{J} and a new cluster C_{new} is defined as C₁, the server can calculate a silhouette value of the new cluster C_{new} for a plurality of reference clusters C_{ref} in accordance with the following [Equation 1].

$$s ( i ) = \frac{b ( i ) - a ( i )}{max ( a ( i ) , b ( i ) )} , \\ a ( i ) = \frac{1}{\vert {C}_{j} \vert - 1} {\sum }_{j ∈ {C}_{j} , j = i} d ( i , j ) , \\ b ( i ) = \text{?} \frac{1}{\vert {C}_{j} \vert} {\sum }_{j ∈ {C}_{j}} d ( i , j ) \qquad [ Equation 1 ]$$

$$\text{?} \text{indicates text missing or illegible when filed}$$

(s(i) is a silhouette value, I is an environmental variable included in the new cluster C_{new}, j is an environmental variable included in the reference cluster C_{ref}, and d(i,j) is the distance between i and j)

The server 10 can calculate a silhouette value for each of all environmental variables in the new cluster C_{new} and can determine similarity proportional to the mean of the silhouette values.

Further, the server 10 can calculate a silhouette value for each of all of the environmental variables not only in the new cluster C_{new}, but the reference clusters C_{ref}, and can calculate a silhouette coefficient on the basis of the mean silhouette value of each of the clusters, as in the following [Equation 2].

$$SC = {max}_{1 < k < K} \tilde{s} ( k ) \qquad [ Equation 2 ]$$

(K is the total number of clusters and \tilde{s}(k) is a mean silhouette value of the k-th cluster).

The server 10 can determine similarity proportional to a silhouette coefficient.

When similarity calculated in accordance with the method described above is less than a reference value, the server 10 can additionally use new environmental variables for reinforcement learning of the neural network model 100. That is, the less the environmental variables collected from the new power plant 22 are similar to the environmental variables collected from existing power plants 21, the lower the accuracy in power generation prediction operation of the neural network model 100 for the new power plant 22 may be. However, when the environmental variables collected from existing power plants 21 are similar to the environmental variables collected from existing power plants 21, the accuracy in power generation prediction of the neural network model 100 for the new power plant 22 may be high even without specific learning.

In consideration of this matter, the server 10 can additionally reinforcement-train the neural network model 100 using the new environmental variables when similarity is lower than the reference value, and can use the existing neural network model 100 as it is for power generation prediction operation for the new power plant 22 when similarity is higher than the reference value.

Meanwhile, when similarity is calculated on the basis of the distances between the representative values of reference clusters C_{ref} and the representative value of a new cluster C_{new} in the examples of calculating similarity described above, a plurality of similarities may be calculated. In this case, when all of the plurality of similarities are lower than the reference value, the server 10 can additionally reinforcement-train the neural network model 100, and when even any one of the plurality of similarities is higher than the reference value, the server 10 can use the existing neural network model 100 as it is for power generation prediction operation for the new power plant 22.

Referring to FIG. 5 again, when a new cluster C_{new} and reference clusters C_{ref} are formed at completely different locations, similarity may be calculated lower than the reference value. In this case, the server 10 can additionally reinforcement-train the neural network model 100 using new environmental variables included in the new cluster C_{new}.

However, referring to FIG. 6 again, when a new cluster C_{new} is formed at a location very close to reference clusters C_{ref}, similarity may be calculated higher than the reference value. In this case, the server 10 can perform power generation prediction operation by the existing neural network model 100 on each of distributed power plants 20 without additionally training the neural network model 100.

Meanwhile, since whether to additionally train the neural network model 100 should be quickly determined, the server 10, as described above, can collect environmental variables only for a short time from the new power plant 22. However, as time passes, the environment around the new power plant 22 may change and environmental variables also may change.

In consideration of this matter, even though determining that similarity calculated before exceeds the reference value and it is not required to additionally train the neural network model 100, the server 10 can collect again new environmental variables from the new power plant 22 after a preset time.

After collecting again new environmental variables, the server 10 can continuously determine whether to additionally reinforcement-train the neural network model 100 by repeating the operation of the step S20 and the step S30.

As described above, when power generation of multiple distributed power plants 20 is predicted through the neural network model 100, whether to additionally reinforcement-train the neural network model 100 is determined on the basis of environmental variables collected from a new power plant 22, whereby the present disclosure has the advantage that it is not required to train the neural network model 100 using a lot of time and resources every time a plant 20, which is a subject of management, is introduced when integrally managing the multiple power plants 20.

Although the present disclosure was described with reference to the exemplary drawings, it is apparent that the present disclosure is not limited to the embodiments and drawings in the specification and may be modified in various ways by those skilled in the art within the range of the spirit of the present disclosure. Further, even though the operation effects according to the configuration of the present disclosure were not clearly described with the above description of embodiments of the present disclosure, it is apparent that effects that can be expected from the configuration should be also admitted.

What is claimed is:

1. A power generation prediction method for distributed power plants using reinforcement learning, the method predicting power generation of each of a plurality of distributedly installed power plants using a neural network model by means of a server in a management system that is connected with the power plants and manages the power plants and the method comprising:
creating a plurality of reference clusters by clustering environmental variables accumulatively collected from each of the power plants by means of the server;
creating a new cluster by collecting new environmental variables from a new power plant and by clustering the new environmental variables by means of the server; and
additionally using the new environmental variables for reinforcement learning of the neural network model when similarity between the plurality of reference clusters and the new cluster is less than a reference value, and collecting again new environmental variables from the new power plant after a preset period when the similarity exceeds the reference value by means of the server.

2. The power generation prediction method of claim 1, wherein the neural network model uses an environmental variable for each date as a state value, uses predicted power generation for each date as an action value, and is reinforcement-trained by a reward value inversely proportional to a difference between actual power generation and the predicted power generation for each date.

3. The power generation prediction method of claim 1, wherein the creating of reference clusters comprising:
accumulatively collecting the environmental variables from a plurality of environmental sensors provided for each of the power plants; and
creating a plurality of reference clusters by clustering the accumulatively collected environmental variables.

4. The power generation prediction method of claim 1, wherein the collecting of new environmental variables comprises collecting new environmental variables that are the same kind as the environmental variables accumulatively collected from a plurality of environmental sensors provided for a new power plant, respectively, that is not registered on a database.

5. The power generation prediction method of claim 1, wherein the additionally using of the new environmental variables for reinforcement learning comprises calculating a distance between a representative value of each of the plurality of reference clusters and a representative value of the new cluster.

6. The power generation prediction method of claim 1, wherein the additionally using of the new environmental variables for reinforcement learning comprises calculating distances between representative values closest to centers of the reference clusters in environmental variables included in the plurality of reference clusters and a representative value closest to a center of the new cluster in environmental variables included in the new cluster.

7. The power generation prediction method of claim 1, wherein the additionally using of the new environmental variables for reinforcement learning comprises calculating distances between representative values closest to means of the reference clusters in environmental variables included in the plurality of reference clusters and a representative value closest to a mean of the new cluster in environmental variables included in the new cluster.

8. The power generation prediction method of claim 1, wherein the additionally using of the new environmental variables for reinforcement learning comprises calculating a silhouette coefficient for the plurality of reference clusters and the new cluster.

9. The power generation prediction method of claim 1, wherein the additionally using of the new environmental variables for reinforcement learning comprises calculating a silhouette value of the new cluster for the plurality of reference clusters.
